(19) United States
(12) Patent Application Publication
(10) Pub. No.: US 2009/0315340 A1
(43) Pub. Date: Dec. 24, 2009

(54) ROTATABLE GRIP FOR A PHOTOGRAPHIC CAMERA

(75) Inventor: Helmut Koecher, Braunschweig (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: JENOPTIC LASER, OPTIK, SYSTEME GMBH, Jena (DE)

(21) Appl. No.: 12/442,210

(22) PCT Filed: Sep. 21, 2007
(86) PCT No.: PCT/DE07/01707

§ 371 Date: Mar. 20, 2009

(30) Foreign Application Priority Data
Sep. 21, 2006 (DE) 102006045602.5

(51) Int. Cl. E05C 19/10

(52) U.S. Cl. 292/117

(57) ABSTRACT

A rotatable grip for cameras provides a grip and a latching mechanism attachable to a camera body. The latching mechanism having a bearing ring, a grip plate, a leaf spring and steel balls. The leaf spring and bearing ring are connected to the camera body with the balls being pushed into holes of the grip plate by the leaf spring. On rotation of the grip, the balls are pushed out of the hole of the grip plate counter to the spring force. The grip pivots until the balls latch in the desired position into the holes of the selected latch position. To secure a selected latch position, a blocking plate pivots to block the latch balls from moving.

### PRIORITY CLAIM

The present application is a National Phase entry of PCT Application No. PCT/DE2007/001707, filed Sep. 21, 2007, which claims priority from German Application Number 102006045602.5, filed Sep. 21, 2006, the disclosures of which are hereby incorporated by reference herein in their entirety.

### FIELD OF THE INVENTION

The invention relates to a rotatable grip for photographic cameras, especially reflex cameras. The grip in accordance with the invention is connected by a latching mechanism with the base body of the camera.

### BACKGROUND OF THE INVENTION

Cameras are known which are equipped with rotatable grips in a large variety of arrangements. A reflex camera with pistol grip is described in U.S. Pat. No. 4,405,223, in which the grip is fastened by means of a holding bracket construction. The pivoting capability is substantially limited in this case and leads to a loosening of the holding elements over the course of use. A pivoting holding grip construction in a reflex camera is known from DE 19534231. The disadvantageous aspect in this construction is however that the latching means have too much play and thus have a disadvantageous effect on the handling properties.

### SUMMARY OF THE INVENTION

In a particular embodiment, features and advantages include providing a photographic camera with a housing and a rotatable grip positioned on the side wall of the housing which is easy to use, can be turned to ergonomically advantageous positions and is provided in a play-free manner in order to thus considerably improve the practical value of the camera.

In a particular embodiment a latching mechanism is arranged between the housing of the camera and the grip and rotatably connects the two with each other. A play-free latching mechanism comprises, arranged one after the other, of a bearing ring, a grip plate, a leaf spring and steel balls deposited therein with a form-fit. Leaf spring and bearing ring are connected to the base body of the camera in accordance with the invention in such a way that the balls are pushed into the holes of the grip plate by the leaf spring. The connection is preferably effected with the aid of a screw connection. By turning the grip, the balls are pushed out of the hole of the grip plate against the spring force. The grip is pivoted until the balls latch in the desired position into the holes of the selected latch position.

The invention will be explained below in closer detail by way of example by reference to the enclosed drawings which also disclose features relevant to the invention.

### BRIEF DESCRIPTION OF THE DRAWINGS

FIG. 1 shows the side view of a photographic camera (K) with a rotatable grip (1) fastened to its housing;

FIG. 2 shows the exploded view of the latching mechanism with blocking plate and cover plate;

FIG. 3 shows the latching mechanism on the base body of the camera;

FIG. 4 shows the latching mechanism on the base body of the camera without the cover plate;

FIG. 5 shows the latching mechanism on the base of the camera without cover plate and catch;

FIG. 6 shows the grip in connection (arrangement) with the exploded view of the latching mechanism in the direction towards the camera;

FIG. 7 shows a view from the camera onto the latching mechanism with slide and pin (blocking).

### DETAILED DESCRIPTION

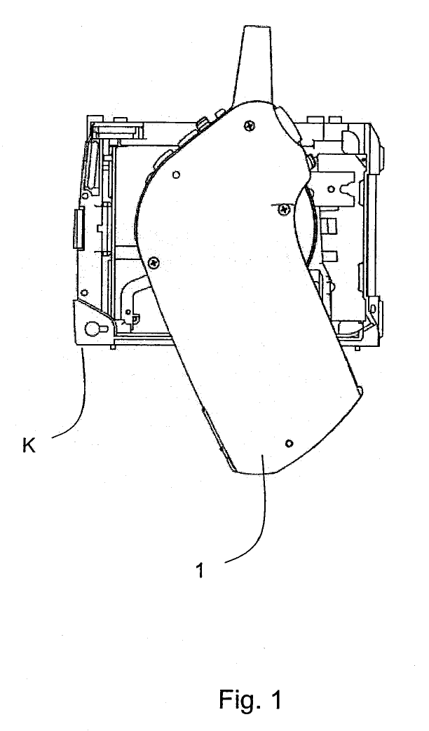

A field of application of the apparatus in accordance with the invention is shown in the embodiment as shown in FIG. 1. The application is not limited to such types of cameras. The invention is also not limited to certain measurements and dimensional relationships of the illustrated shapes.

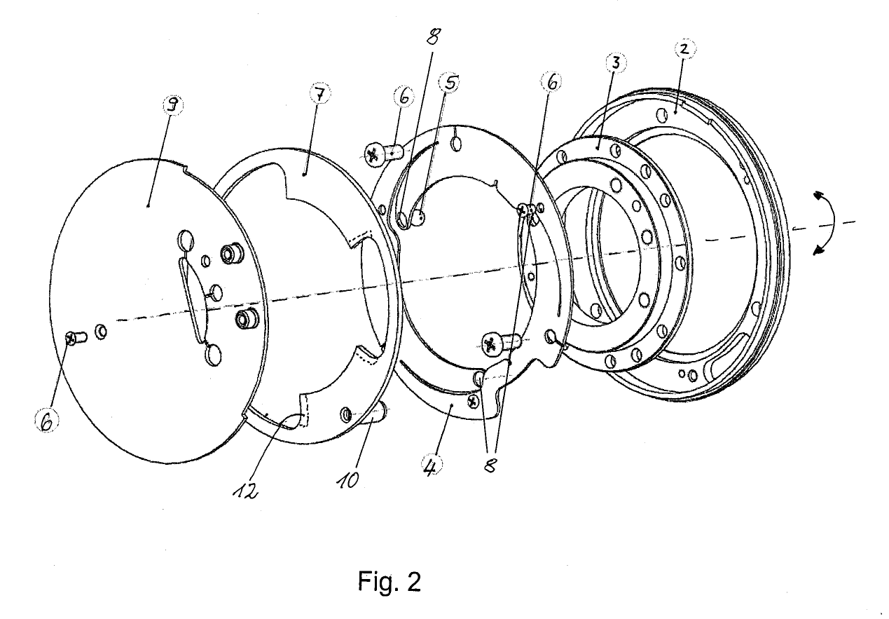

FIG. 2 shows the structure of the latching mechanism on the basis of the exploded view. When screwed together, the construction leads to the consequence that it has absolute freedom from play in accordance with the invention and there are no rattling noises. The arrows symbolize the rotational movement in the blocking direction and unblocking direction of the grip.

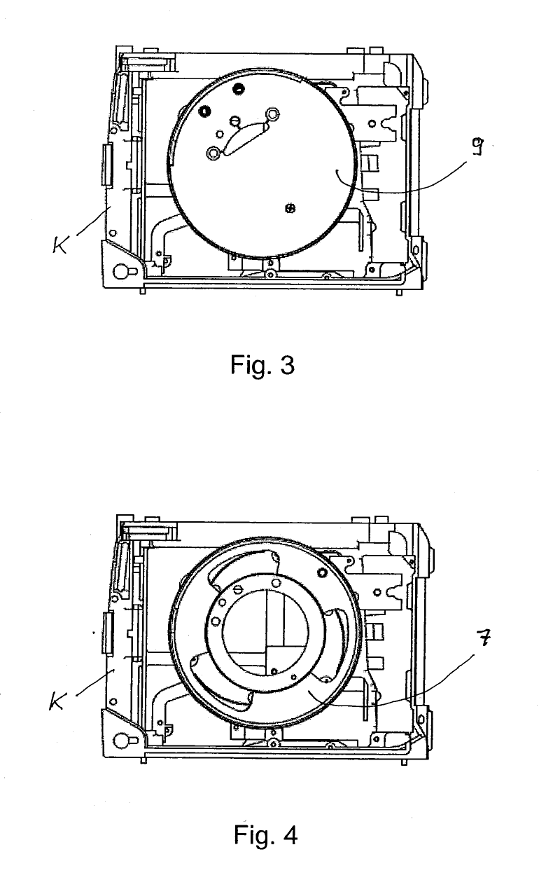

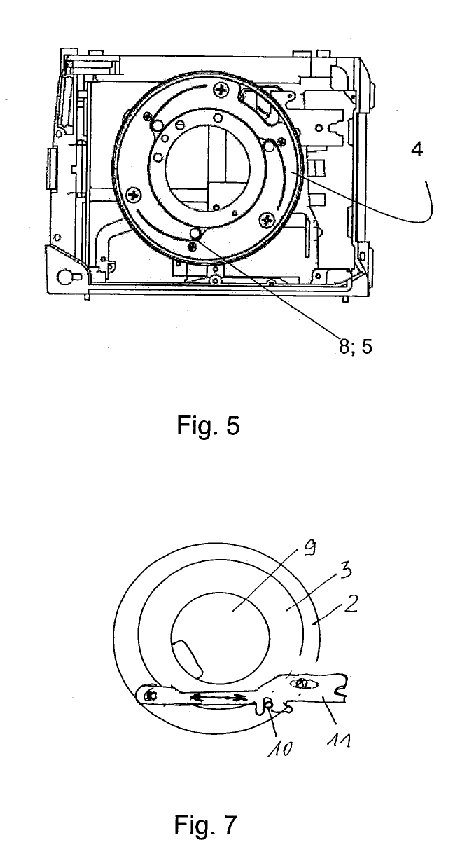

FIGS. 3 to 5 successively show the latching mechanism on the camera housing in a side view (without grip), complete with cover plate (FIG. 3), latching mechanism without cover plate (FIG. 4) and latching mechanism without cover plate and blocking plate (FIG. 5).

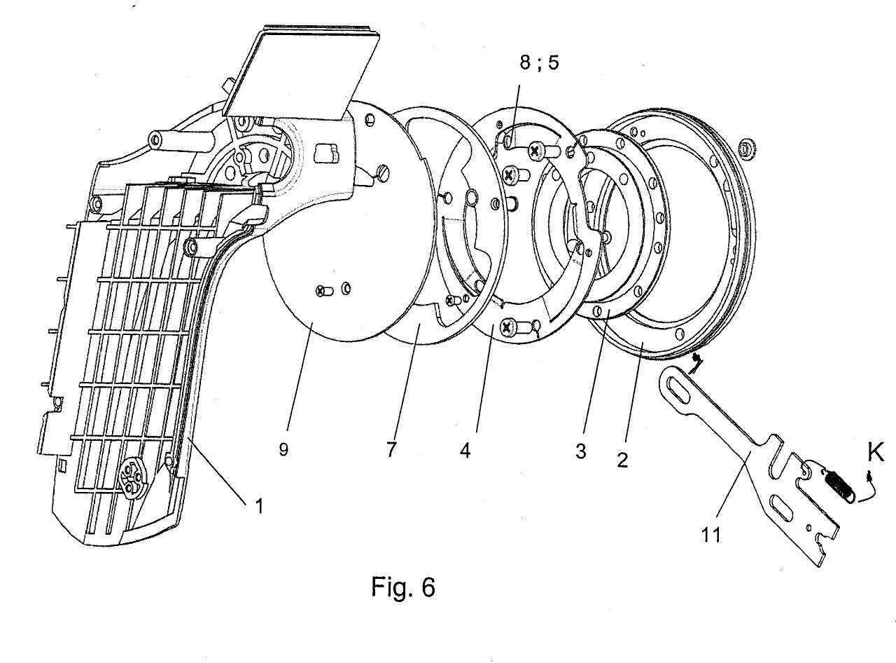

FIG. 6 shows the arrangement with the grip and exploded view. The slide (11) is fastened behind the bearing ring (2) and blocks or unblocks the blocking plate via the pin (10).

FIG. 7 again shows the movement of the slide (translational) which engages with its bracket in the pin (10) of the blocking plate and actuates the same.

Referring to all of the figures, in a particular embodiment a latching mechanism is arranged between the housing of the camera (K) and the grip (1) and rotatably connects the two with each other. A play-free latching mechanism comprises, arranged one after the other, of a bearing ring (2), a grip plate (3), a leaf spring (4) and steel balls (5) deposited therein with a form-fit. Leaf spring (4) and bearing ring (2) are connected to the base body of the camera in accordance with the invention in such a way that the balls are pushed into the holes (8) of the grip plate (3) by the leaf spring (4). The connection is preferably effected with the aid of a screw connection (6). By turning the grip (1), the balls (5) are pushed out of the hole of the grip plate (3) against the spring force. The grip (1) is pivoted until the balls (5) latch in the desired position into the holes of the selected latch position.

In order to secure the selected latch position, the movement of the latch balls (5) can be prevented by a blocking plate (7) which can pivot about the axis of rotation of the grip plate (3). The blocking plate (7) is supported axially on the cover plate (9) which is screwed together with the grip plate (3). The blocking plate (7) comprises wedge areas (12) which completely fill out the space between balls and cover plate during the pivoting to the blocked position. By suitably choosing the wedge angle, the latch balls cannot be pressed out of the holes again. In a special embodiment, said wedge angle is between 5° and 15°, preferably 10°. The wedge areas (12) are disposed on the bottom side of the blocking plate, the side facing the camera. The position of the blocking plate is supported by a spring and the grip is held in a play-free manner in the latched and blocked position. Only when the blocking plate is pivoted against the spring from the blocked position will it release the movement of the balls and the grip can be pivoted again to any desired latched position. With the help of the translational movement of a slide (11), the movement of the blocking plate (rotational movement) can be performed. Slide (11) and blocking plate (7) are connected with each other via a pin (10).

The leaf spring (4) is preferably an integral leaf spring with three movable tongues. The leaf spring is arranged in such a way that the tongues are movable independent of each other. A hole is provided in each of the tongues, in which a latching ball each is disposed.

In another embodiment, the leaf spring (4) can also consist of four or five mutually independent tongues with a latch ball each.

1-12. (canceled)

13. A rotatable grip for photographic cameras, wherein a grip is rotatable by a latching mechanism which connects the grip with a camera, the latching mechanism comprises, arranged one after the other from the camera, a bearing ring, a grip plate, a leaf spring and latching balls deposited therein with a form-fit, the leaf spring and the bearing ring being connected with the base body of the camera such that the balls are pressed by the leaf spring into the holes of the grip plate.

14. A rotatable grip for photographic cameras according to claim 13, further comprising a blocking plate rotatable about the rotational axis of the grip plate and is arranged behind the leaf spring wherein the movement of the latching balls is prevented by the blocking plate.

15. A rotatable grip for photographic cameras according to claim 14, wherein the latching mechanism and the blocking plate are sealed off with a cover plate which is in direct contact with the grip.

16. A rotatable grip for photographic cameras according to claim 13, wherein the latching mechanism is rigidly connected with a cover plate.

17. A rotatable grip for photographic cameras according to claim 13, wherein the latching mechanism is rigidly connected with the cover plate with a screwed joint.

18. A rotatable grip for photographic cameras according to claim 14, wherein the blocking plate is in connection via a blocking pin by means of a slide arranged between the bearing ring and the camera.

19. A rotatable grip for photographic cameras according to claim 14, wherein the blocking plate comprises wedge areas which completely fill the space between the latching balls and the cover plate during the pivoting into the blocked position.

20. A rotatable grip for photographic cameras according to claim 19, wherein the wedge areas have wedge angles of between 5° and 15°.

21. A rotatable grip for photographic cameras according to claim 20, wherein the wedge areas have wedge angles of 10°.

22. A rotatable grip for photographic cameras according to claim 13, wherein the leaf spring is an integral leaf spring with three movable tongues.

23. A rotatable grip for photographic cameras according to claim 13, wherein the leaf spring consists of four or five mutually independent tongues each with a latching ball.

24. A rotatable grip for photographic cameras according to claim 13, wherein the tongues of the leaf spring each comprise a hole in which a latching ball each is disposed.

25. A rotatable grip for a photographic camera comprising a grip connecting to a latching mechanism, the latching mechanism connectable to the camera, the latching mechanism comprising:
a leaf spring with a plurality of arcuate movable tongues positioned about a rotation axis, each tongue with a latching balls retained therein with a form-fit; and
a grip plate rotatably engaged with the leaf spring whereby the balls are pressed by the leaf spring into positions on the grip plate, whereby rotation of the camera with respect to the grip about the rotation axis rotates the grip plate with respect to the leaf spring.

26. A rotatable grip for a photographic cameras according to claim 25, further comprising a blocking plate that rotates about the rotational axis for blocking the movement of the latching balls with respect to the grip plate.
